(19) United States
(12) Patent Application Publication
(10) Pub. No.: US 2017/0173802 A1
(43) Pub. Date: Jun. 22, 2017

(54) COBOTIC MANIPULATOR

(71) Applicants: COMMISSARIAT A L'ENERGIE ATOMIQUE ET AUX ENERGIES ALTERNATIVES, Paris (FR); SARRAZIN TECHNOLOGIES, Perrecy-les-Forges (FR)

(72) Inventors: Olivier DAVID, IGNY (FR); Philippe GARREC, GIF-SUR-YVETTE (FR); Sylvain ANDRE, PERRECY-LES-FORGES (FR)

(73) Assignees: COMMISSARIAT A L'ENERGIE ATOMIQUE ET AUX ENERGIES ALTERNATIVES, PARIS (FR); SARRAZIN TECHNOLOGIES, Perrecy-les-Forges (FR)

(21) Appl. No.: 15/313,680

(22) PCT Filed: May 19, 2015
(86) PCT No.: PCT/EP2015/061031

§ 371 Date: Nov. 23, 2016

(30) Foreign Application Priority Data
May 27, 2014 (FR) 1454796

(51) Int. Cl. B25J 19/00; F16F 15/28

(52) U.S. Cl. CPC B25J 19/0008; F16F 15/28; B25J 19/00

(57) ABSTRACT

Load manipulating device (1) including a load manipulator (10) including at least two segments (13, 18) articulated with respect to each other, comprising a boom segment (13) that is similarly articulated on a frame (12) and a balance segment (18) which comprises an end intended to receive a load (20) to be manipulated, the load manipulating device (1) including balancing means (41, 23, 24) such that the load manipulator (10) is stable in any position, whether or not bearing the load, and guidance means (50, 60, 70) distinct from the balancing means for constraining the position of the load manipulator (10).

### FIELD OF THE INVENTION

The invention relates to the field of cobotics and more specifically to load manipulating devices.

### STATE OF THE ART

Many industrial activities entail the manipulation and transport of loads. The standards relating to worker protection generally restrict the admissible loads that can be manipulated by a man without assistance to loads in the range between 100 N and 350 N. Beyond that figure, mechanical assistance is required, inter alia by means of load manipulators.

Load manipulators comprising a vertical jib, from which there extends a succession of horizontal arms articulated to one another about vertical axes, and of which the final arm comprises an end intended to be connected to the load to be manipulated, are already familiar. Balancing means for the load absorb the vertical forces either in the area of the end of the final articulated arm with the help of a cable winch, or in the area of the jib with the help of a vertical cylinder.

The precision of winch manipulators presents a problem in certain applications, since they do not permit precise positioning due to the dangling of the load suspended at the end of the cable and to friction in the articulations of the arms. Manipulators with a vertical cylinder, for their part, are insensitive to the dangling of the load, but do not permit guiding of the latter. The vertical cylinder permits optimal adjustment of the height of the load subject to position control. Said devices are used, therefore, in order to facilitate the handling of a load by balancing the latter, the positioning and the guiding of the load being assured by the operator. Such a device permits the performance of a large variety of tasks. However, the precision of the positioning of the load depends on the operator, which may impact on the rapidity and the quality of execution of a task when it requires precise positioning of the load or travelling on a particular trajectory.

There are similarly robotic load manipulators comprising a base, articulated on which is an assembly of arms that are linked to each other by geared motors equipped with rotary coders, the information from which is transmitted to a processing unit. One of the arms comprises an end intended to be connected to a load. Said arms are able to perform extremely precise guiding of the load thanks to the coders that are linked to the geared motors, which similarly each develop torques permitting balancing of the manipulator when unladen or when laden. The rotary coders permit the processing unit to define precisely the position of each of the arms, to deduce therefrom the position of the load within a frame of reference connected to the manipulating device, and thus to define the controls to be sent to the geared motors in order to position the component precisely within said frame of reference. Such devices develop high forces when they are guiding the load and are accordingly capable of injuring an operator in the vicinity or of causing damage to the load or its environment. Said devices are thus generally intended to carry out limited tasks, in an autonomous manner, and are not suitable for collaborative utilization with the user.

### OBJECT OF THE INVENTION

One aim of the invention is to permit the guiding of a manipulated load with a reduced risk to the operator undertaking the manipulation.

### SUMMARY OF THE INVENTION

A load manipulating device including a load manipulator comprising at least two segments articulated with respect to one other, comprising a boom segment that is also articulated on a frame and a balance segment which comprises an end intended to receive a load to be manipulated, is proposed for this purpose. According to the invention, the load manipulating device comprises balancing means such that the load manipulator is stable in any position, whether or not bearing the load, (that is to say that the uncertainty of the balancing is lower than the value of the friction in any position) and guidance means for constraining the position of the load manipulator. Thus, given that the guidance means is distinct from the balancing means of the load, it is possible to have a load manipulating device of high capacity, but of which the guiding actuators exert forces that are significantly lower than the counterbalancing forces and which are thus without danger for the load, its environment and/or the operator manipulating the device. The guidance means make it possible to define trajectories by exerting return forces towards a defined trajectory on the segments of the manipulator. An anti-collision function may similarly be obtained by exerting forces which tend to divert the load from a prohibited zone on the segments of the manipulator.

In one advantageous embodiment, the manipulator comprises a connecting rod parallel to a boom segment articulated on the frame. The boom segment and the connecting rod have first ends articulated on a balance segment, of which one end is intended to be connected to the load to be manipulated. The second ends of the boom segment and of the connecting rod are connected by a rod in such a way as to form an articulated deformable parallelogram. According to this embodiment, the balancing means comprise balancing means when unladen to balance the load manipulator when unladen and balancing means when laden to balance the load manipulator when laden. It is thus possible to provide permanent balancing of the load manipulator when unladen, for example, by utilizing an assembly of counterweights that is independent of the specific balancing of the load, which may be accomplished by more costly means, such as cylinders.

According to a particular embodiment, the load manipulating device comprises means of measuring the position of each of the elements of the load manipulator and means of three-dimensional modelling of the elements of the load manipulator, of its environment and/or of the load intended to be connected to the end of the balance segment, the device similarly comprising means of processing modelled elements in order to detect a movement of the load manipulator that could lead to a collision between the modelled elements, and in order to send an instruction to the guidance means of the manipulator in order for the guidance means to generate a force opposing the movement that could lead to the collision. As a consequence, rather than establishing blocking points of the arms and/or of the load when it reaches a prohibited position (forced position) that could lead to jolts in the movement of the manipulator, the load manipulating device exerts a force opposing the continuation of the movement. Such a force is easier to interpret by the operator of the manipulator and improves the ergonomics and the comfort at work (reduction in vibrations and resistances perceived by the user).

According to a preferred embodiment, the guidance means of the manipulator comprise a cable-actuated cylinder. Cable-actuated cylinders are compact actuators which may be utilized equally for the application of a force and for the measurement of a displacement. Said actuators may similarly be utilized in order to provide compensation of the friction in the articulations of the manipulator.

According to another embodiment, the means of processing the modelled elements comprise storage means for at least one modelling of a reference trajectory of the load to be manipulated, the means of processing the modelled elements being arranged in order to detect a movement of the load manipulator that could lead to a difference between the modelling of the trajectory of the load and the modelling of the reference trajectory, and in order to send an instruction to the guidance means of the load manipulator in order for them to generate a force opposing the movement of the load manipulator that could lead to a difference between the modelling of the trajectory of the load and the modelling of the reference trajectory.

The guiding thus obtained offers greater operating convenience, since it does not bring about abrupt contacts by the manipulator against a movement imposed by the operator. The guiding is fluid, in the absence of pressure points, which limits the onset of musculoskeletal disorders and permits the improvement of the ergonomics and the convenience at work.

According to another embodiment, the load manipulating device comprises a second load manipulator positioned parallel with a first load manipulator, and the ends of each manipulator are connected to the load to be manipulated by means of connection comprising at least one ball joint, the device similarly comprising means for controlling the balancing means of each manipulator.

Advantageously, the means of connection comprise means for balancing the rotation of the load about an axis connecting the ends of the manipulators.

### BRIEF DESCRIPTION OF THE DRAWINGS

Reference is made to the accompanying figures, in which:

FIG. 1 is a schematic view from the side of a first embodiment of the load manipulating device according to the invention;

FIG. 2 is a view from the side of the device depicted in FIG. 1 from an opposing point view at 180 degrees;

FIG. 3 is a partially cut-away schematic view in perspective of the device depicted in FIG. 1;

FIG. 4 is a detailed view in perspective of the manipulating device depicted in FIG. 1;

FIG. 5 is a similar view to that depicted in FIG. 4, in which a part of the hidden elements has been made apparent;

FIG. 6 is a detailed view in perspective from above of the manipulating device depicted in FIG. 1;

FIG. 7 is a detailed rear view in perspective of the manipulating device depicted in FIG. 1;

FIG. 8 is a schematic view of the manipulating device depicted in FIG. 1 in a working position;

FIG. 9 is a similar view to that depicted in FIG. 8, in which the device according to the invention is in an anti-collision position;

FIG. 10 is a similar view to that depicted in FIG. 8, in which the manipulator is in a position for guiding the load;

FIG. 11 is a view in perspective of a second particular embodiment of a load manipulating device according to the invention;

FIG. 12 is a detailed view in perspective of the embodiment depicted in FIG. 11;

FIG. 13 is a detailed view in perspective of a third particular embodiment of a load manipulating device according to the invention.

### DETAILED DESCRIPTION OF THE INVENTION

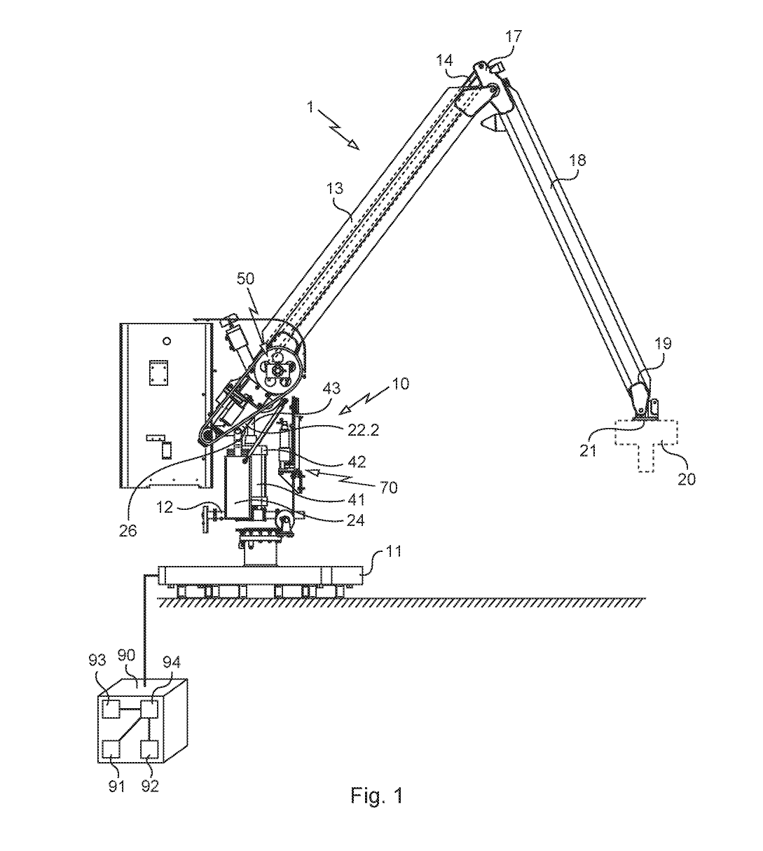

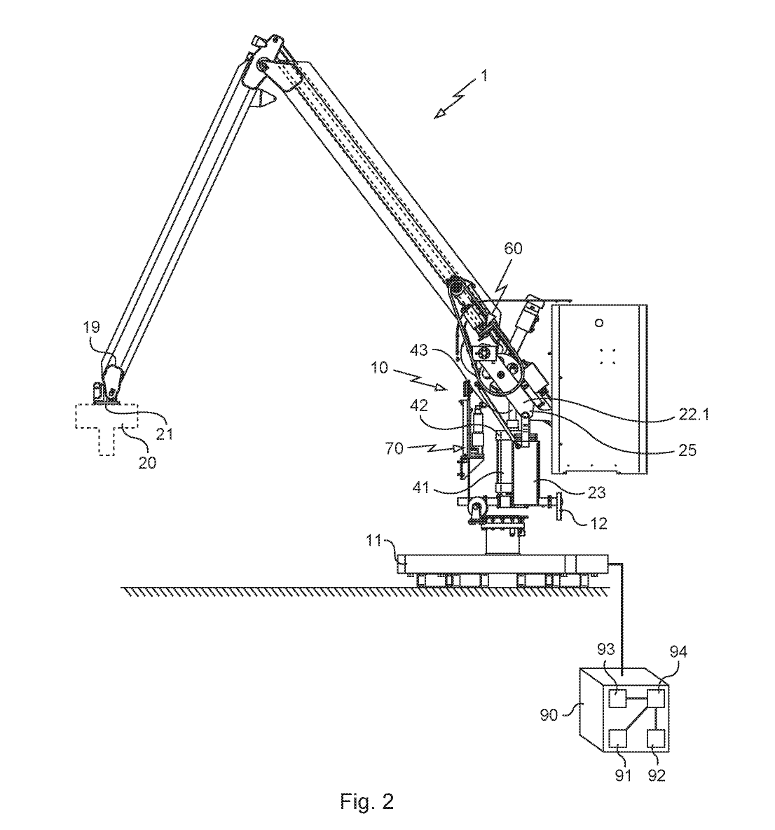

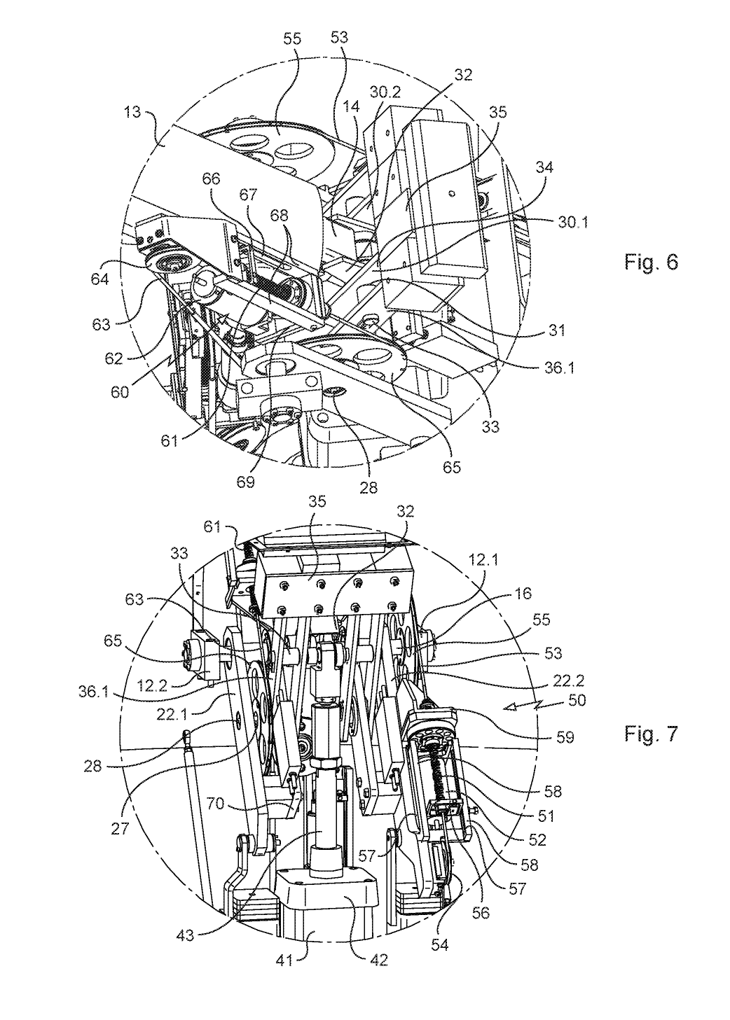

With reference to FIGS. 1 to 7, the load manipulating device generally designated with 1 comprises a load manipulator 10 linked to a monitoring unit 90.

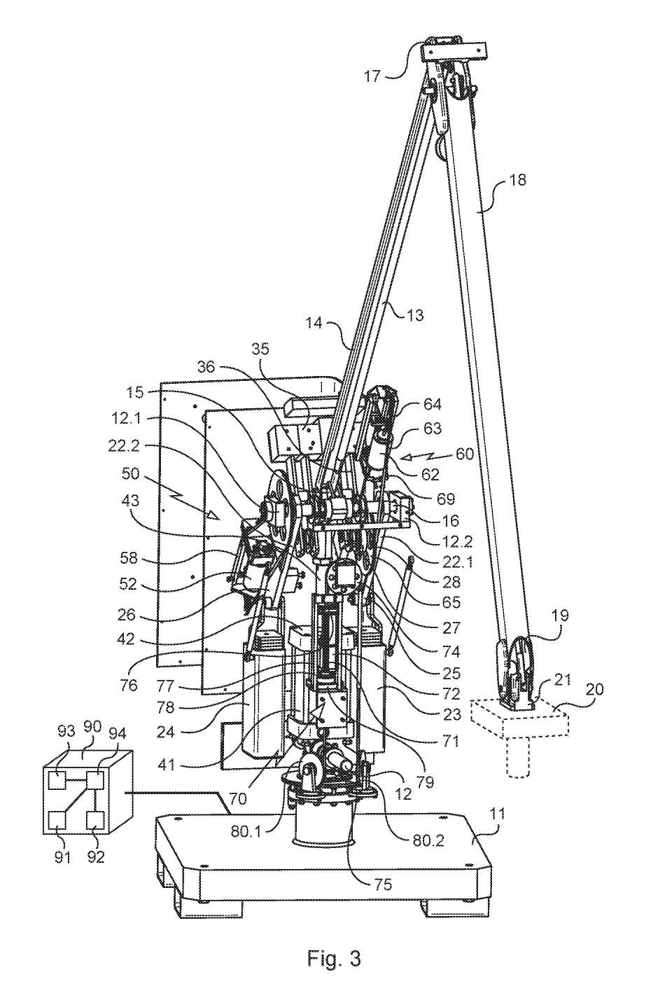

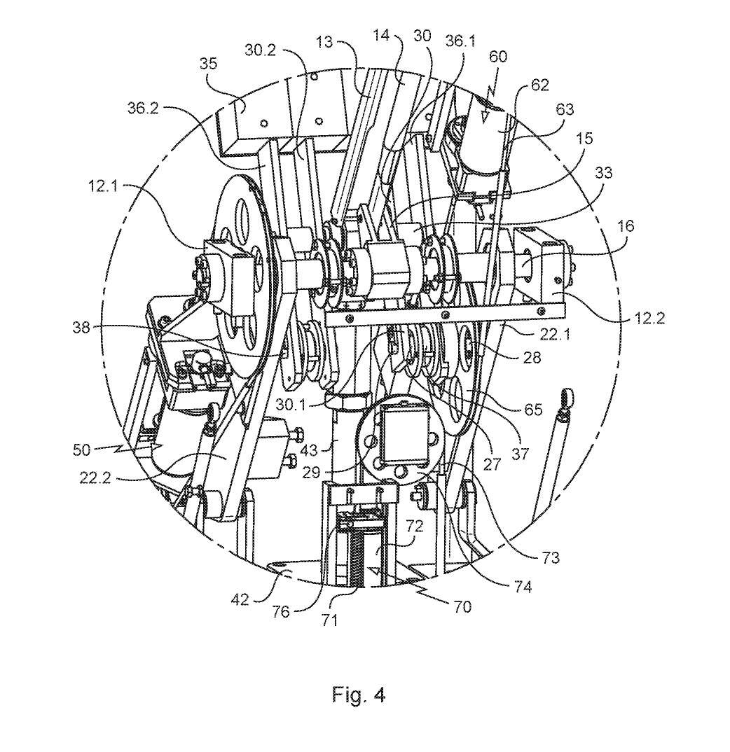

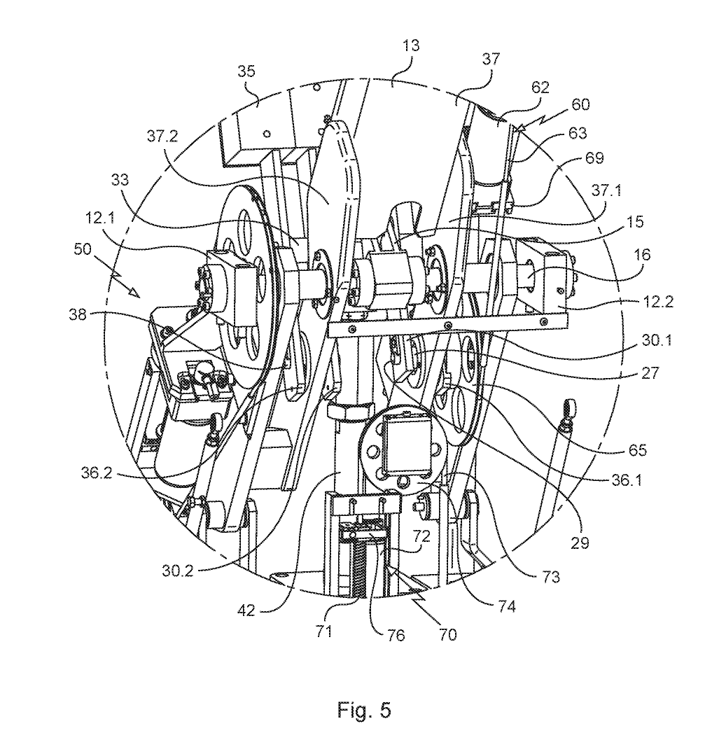

The manipulator 10 rests on a horizontal surface and comprises a support 11, on which a frame 12 (partially represented for reasons of clarity) is rotatably mounted about a vertical shaft. A mutually parallel boom segment 13 and a connecting rod 14 extend from the frame 12. As is visible in FIGS. 3 and 4, the connecting rod 14 is articulated on a rod 15 that is integral with a horizontal shaft 16 rotatably mounted on two bearing blocks 12.1 and 12.2 that are integral with the frame 12. As is more particularly visible in FIG. 5, the boom segment 13 comprises a box section extending around the connecting rod 14 and which is articulated on the shaft 16.

A first portion 17 of a balance segment 18 connects the respective distal ends of the boom segment 13 and of the connecting rod 14. The end 19 of the balance segment 18 opposite the portion 17 comprises means of connection to a load 20 to be manipulated, in this case in the form of an attachment plate 21.

Two supports 22.1 and 22.2 that are integral with the shaft 16 extend to either side of the rod 15 in a direction substantially parallel to that of the boom segment 13 and of the connecting rod 14. Two counterweights 23 and 24 are respectively articulated on the respective ends 25 and 26 of the supports 22.1 and 22.2.

A shaft 27 articulated on the support 22.1 at its first end 28 extends parallel to the shaft 16 and receives, articulated at its second end 29, a first element 30.1 of a balance 30 similarly articulated at a point 31 on the end 32 of the connecting rod 14 via a shaft 33. The end 34 of the balance 30 is connected to a counterweight 35. As is visible in FIG. 4, a second element 36.1 identical to the element 30 is similarly articulated on the shafts 27 and 33 and comprises an end that is integral with the counterweight 35. With reference to FIG. 5, the first wing 37.1 of a support 37 that is integral with the boom segment 13 is articulated on the shafts 27 and 16. Two elements 30.2 and 36.2, respectively homologous with the elements 30 and 36 and symmetrical to the latter in relation to a vertical plane containing the boom segment 13 and the connecting rod 14, are articulated on a shaft 38 connecting them, as well as on the shaft 33. The second wing 37.2 of the support 37 is articulated, like the first wing 37.1, on the shaft 38 and the shaft 16.

The rod 15 acts as a counterbalance and forms a deformable parallelogram with the boom segment 13, the connecting rod 14 as well as the portion 17 of the balance segment 18.

The counterweights 23, 24 and 35 undertake the balancing of the manipulator 10 when unladen by compensating for the effects of the own weight of its elements. The cylinder 41 of a counterbalancing cylinder 42 is guided in translation in relation to the frame 12, whereas its rod 43 is articulated on the shaft 33, as visible in FIG. 7. This cylinder 42 undertakes the balancing of the manipulator 10 when laden by compensating for the effects of the load 20 on the manipulator 10.

The manipulator 10 similarly comprises three cable-actuated cylinders 50, 60 and 70.

With reference to FIG. 7, the first cable-actuated cylinder 50 comprises, in a manner known per se, a screw 51 driven by an electric motor 52 and traversed by a cable loop 53 wound around a small pulley 54 and a large pulley 55. The screw 51 comprises anti-rotation means in the form of a guide nut 56 interacting with the grooves 57 of two guiding rails 58. The frame 59 of the cable-actuated cylinder 50 is attached to the support 22.2. The small pulley 54 is rotatably mounted on the support 22.2, whereas the large pulley 55 is rotatably mounted on the shaft 16 and is constrained to rotate with the fixed part of the bearing block 12.1. In this way, a rotation of the motor 52 causes a translation of the screw 51 and a displacement of the cable 53. The large pulley 55 being constrained to rotate with the fixed part of the bearing block 12.1, the displacement of the cable 53 then causes a rotation of the cable-actuated cylinder 50, of the support 22.2, of the shaft 16 and of the assembly of the elements that are integral with the shaft 16 about the axis of said same shaft 16. Similarly, the application of a torque by the motor 52 will act against a rotation of the axis 16 in a given direction.

With reference to FIGS. 4 to 6, the cable-actuated cylinder 60 comprises in a similar manner a screw 61, a motor 62, a cable loop 63 wound around a small pulley 64 and a large pulley 65 as well as a guide nut 66 interacting with the grooves 67 of two guiding rails 68. The frame 69 of the cable-actuated cylinder 60 is attached to the support 37. The small pulley 64 is rotatably mounted on the frame 69, whereas the large pulley 65 is rotatably mounted on the shaft 27 and is constrained to rotate with the element 36.1. In this way, a rotation of the motor 62 causes a translation of the screw 61 and a displacement of the cable 63. The large pulley 65 being constrained to rotate with the element 36.1, the displacement of the cable 63 then causes a rotation of said element 36.1 about the shaft 27, and a rotational movement of the end 32 of the connecting rod 14 about the axis of the shaft 27 is thus transmitted by the element 36.1 to the end 32 via the shaft 33. Similarly, the application of a torque by the motor 62 will act against a rotation of the end 32 about the axis of the shaft 27.

A final cable-actuated cylinder 70, which is visible in FIG. 3, comprises in a similar manner a screw 71, a motor 72, a cable loop 73 wound around a small pulley 74 and a large pulley 75 as well as a guide nut 76 interacting with the grooves 77 of two guiding rails 78. The frame 79 of the cable-actuated cylinder 70 is attached to the frame 12. The small pulley 74 is rotatably mounted on the frame 12 about a horizontal axis, whereas the large pulley 75 is rotatably mounted on the frame 12 about a vertical shaft and is constrained to rotate with the support 11. Two idler pulleys 80.1 and 80.2 that are integral with the frame 12 ensure the return of the cable 73 towards the large pulley 75. In this way, a rotation of the motor 72 causes a translation of the screw 71 and a displacement of the cable 73. The large pulley 75 being constrained to rotate with the support 11, the displacement of the cable 73 then causes an associated rotation of the frame 12 in relation to support 11 about a vertical shaft. Similarly, the application of a torque by the motor 72 will act against an associated rotation of the frame 12 in relation to the support 11 about a vertical shaft.

The cable-actuated cylinders 50, 60 and 70 are connected to the monitoring unit 90 and are thus able to perform the following operations:
by the application of a predetermined torque moving in the direction of the movement, to compensate for the residual friction of the different articulations of the manipulator 10 and thereby to facilitate the manual displacement of the load manipulating device 1;
by the measurement of the respective amplitudes and directions of the rotations of the motors 52, 62 and 72, to measure the relative position of the different elements of the manipulator 10 in space, said measurements being capable of being performed by coders 81, 82 and 83 respectively situated in the motors 52, 62 and 72. Calibration permits the position in space of the elements to be defined by the manipulator 10 in absolute terms, and adequate processing of the data then permits the speeds of rotation and the torques to be deduced (by measurement of the current drawn);
by the application of torques opposing the distance of the end of the manipulator 10 from a determined trajectory, to provide intuitive guiding of the manipulator 10.

Because of the presence of the counterweights 23, 24 and of the counterbalancing force when laden exerted by the cylinder 42, the cable-actuated cylinders 50, 60 and 70 are not subjected (or indirectly through inertia) to the effects of the own weight of the elements of the manipulator 10 or of the load to be manipulated 20. This makes it possible to limit the capacity for forces of the cable-actuated cylinders 50, 60 and 70, making the latter without danger to the operator, including in the case of unintentional activation or erroneous amplitude information. For example, for a load 20 to be manipulated, of which the weight is between 0 and 1000 Newtons, the cable-actuated cylinders 50, 60 and 70 exert forces between 0 and 50 Newtons, or a ratio of the weight of the manipulated load/guiding force of up to 20.

In the nominal usage of the manipulating device 1, and in order to increase the safety of the system, the speeds of displacement of the elements of the manipulator 10 may be limited by restricting the supply voltage to the motors 52, 62, 72 of the cable-actuated cylinders 50, 60, 70 and by thus limiting the quantity of kinetic energy that the manipulator 10 may acquire.

The monitoring unit 90 is now described below. This comprises means for the three-dimensional modelling of the elements of the load manipulator 10, depicted here in the form of a three-dimensional modeller 91 in the 3DXML© format, as well as means 92 for processing modelled elements. Said means are generally modules supplementing the three-dimensional modelling motors. The load 20 as well as other elements of the environment of the manipulating device 1 may similarly be modelled. The elements of the load manipulator 10 that are modelled comprise in particular the frame 12, the boom segment 13, the connecting rod 14 and the balance segment 18. Finally, the monitoring unit 90 similarly comprises storage means 93 capable of memorizing a trajectory of the load and/or of the manipulator 10 as well as a processor 94 in connection with the means 91, 92 and 93 acting as a robot controller on the assembly of the elements of the manipulator 10. The monitoring unit 90 is capable of performing logical operations on the modelled elements, of receiving information from the processor 94 on the state of the manipulator 10, and of generating instructions intended for the manipulator 10 in correlation with the state and the constraints applied to the modelled elements.

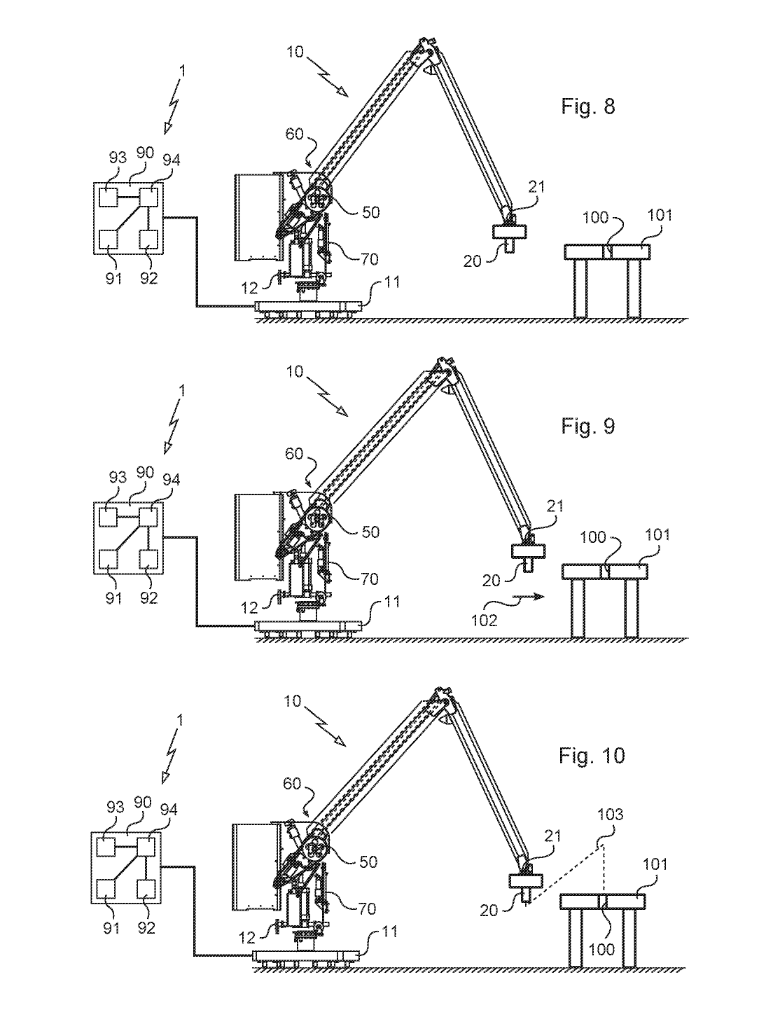

The function of the load manipulating device is described below with reference to FIGS. 8 to 10 and involves the application to the manipulation of a cylindrical load 20 connected to the end 21 of the manipulator 10 and intended to be placed in a bore 100 of a work table 101. The assembly of the elements of the manipulator 10, the load 20 as well as the work table 101 and its bore 100 are modelled beforehand by the three-dimensional modelling motor 91 and are stored by the storage means 93.

When the operator displaces the load manipulator 10, the coders 81, 82 and 83 respectively situated in the motors 52, 62 and 72 of the cable-actuated cylinders 50, 60 and 70 transmit the amplitude and the direction of the relative rotations of each of said motors towards the monitoring unit 90. The means of processing 92 the modelled elements then update, in real time, a modelling of the relative positions of the manipulator 10, of the load 20 and of the table 101. FIG. 9 represents a situation in which the movement of the manipulator 10 (in this case, a displacement on the straight line according to FIG. 9 and represented by the arrow 102) is capable of causing the load 20 to come into collision with the table 101. The means of processing 92 identify this possibility of collision by the analysis of the movements of the modelled elements and send an instruction to one or a plurality of the cable-actuated cylinders 50, 60 and 70 in such a way as to exert a force opposing the movement of the manipulator 10 that could lead to a collision between the load 20 and the worktable 101. In the case of the movement according to the arrow 102, the means of processing will send an instruction to the cable-actuated cylinder 50 in such a way as to move the load 20 back towards the left according to the representation in FIG. 9. Preferably, the force intended to oppose the movement according to the arrow 102 will increase as the means of supervision 90 detect the approach of the load 20 and of the table 100. In this way, the user will become aware an increasing resistance as it continues in the displacement 102 of the load 20.

One thus obtains an anti-collision device for a load manipulator which sends intuitive information that is easily interpreted by the operator and which implements forces that are not capable of injuring the operator.

According to another mode of operation, the storage means 93 of the monitoring unit 90 comprise the modelling of a reference trajectory 103, represented by a dotted line in FIG. 10. In the course of a displacement of the manipulator 10 by the operator, the means 92 of processing the modelled elements update, in real time, a modelling of the position of the load 20. The means 92 of processing similarly analyse the movements of the manipulator 10 in such a way as to detect all movement that could lead to a difference 104 between the modelling of the trajectory of the load 20 and the modelling of the reference trajectory 103 which would be greater than a specific threshold value 105. The threshold value 105 may change in the course of the displacement of the load 20 along the trajectory 103, for example in order to guide the load 20 increasingly precisely as it approaches the bore 101. When the means of processing 93 detect a movement of the manipulator that could lead to a difference 104 greater than the threshold value 105, the means of processing 93 send an instruction to the cable-actuated cylinders 50, 60 and 70 in such a way as to exert a force opposing the movement of the manipulator leading to a difference 104 greater than the threshold value 105. The threshold value may be equal to 0.

This produces a device for guiding a load manipulator which sends intuitive information that is easily interpreted by the operator and which implements forces that are not capable of injuring the operator.

The elements that are identical or similar to those described previously bear a numerical reference increased by two hundred in the following description of the second and third embodiments of the invention.

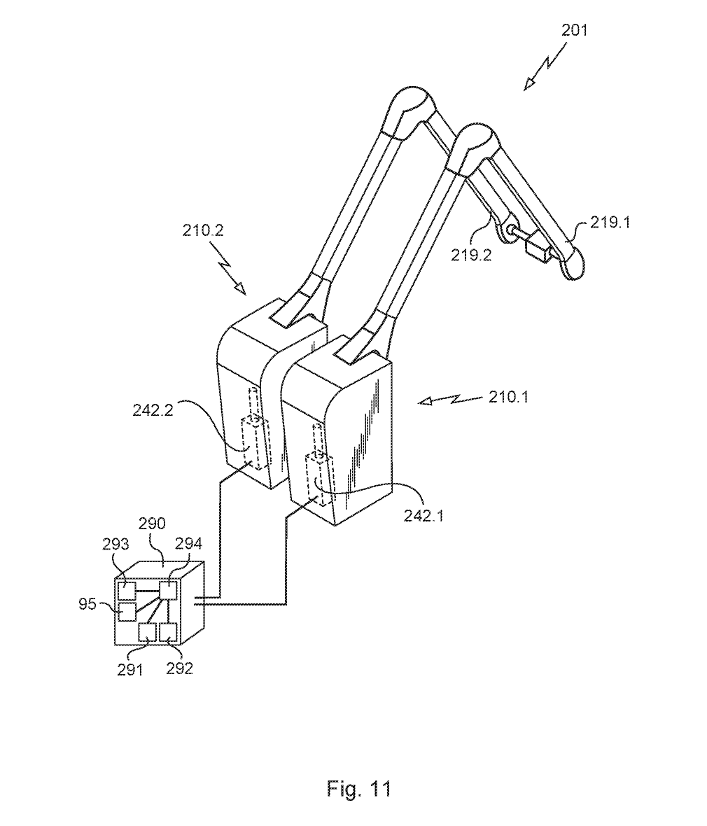

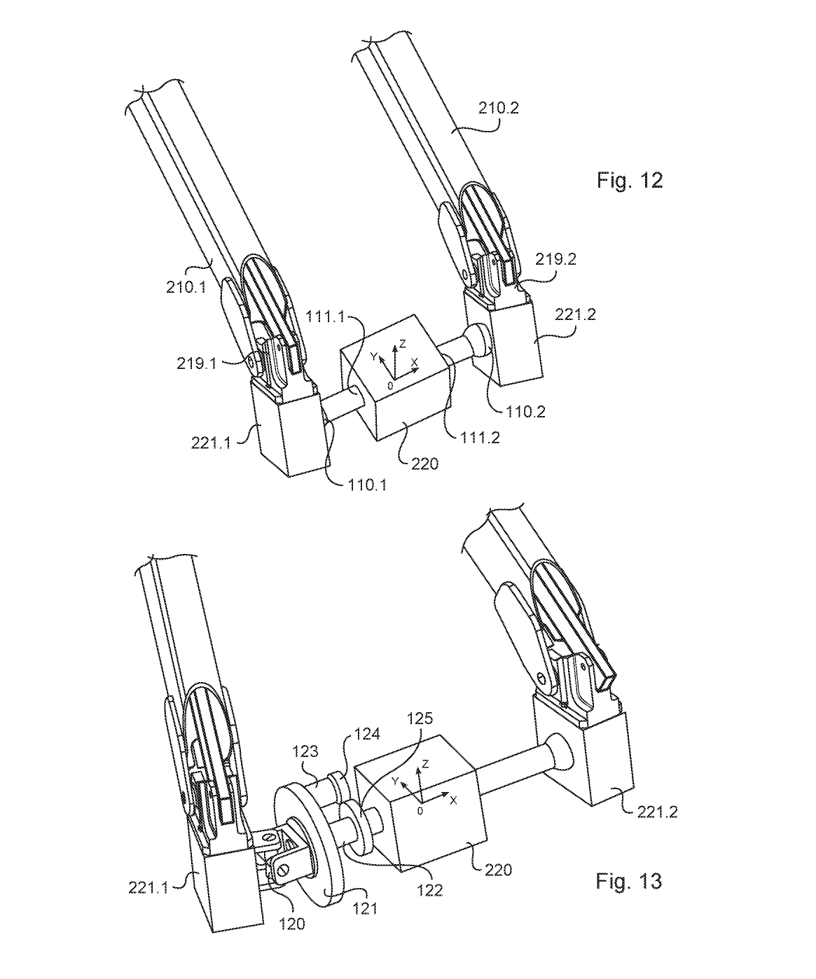

With reference to FIGS. 11 and 12, a second embodiment of the load manipulating device 201 of the invention comprises a first manipulator 210.1 and a second manipulator 210.2 that are positioned in parallel, and of which the respective ends 219.1 and 219.2 comprise the attachment plates 221.1 and 221.2 of the load 220 to be manipulated. The plates 221.1 and 221.2 are identical and each carry a ball pin 110.1 and 110.2, of which the ends 111.1 and 111.2 opposite the ball joints are attached to the load 220. The axes 111.1 and 111.2 thus leave the load 220 to rotate freely about an axis joining the centres of the ball joints 110.1 and 110.2.

The manipulators 210.1 and 210.2 are both connected to the same monitoring unit 290, which comprises additional means 95 for controlling the counterbalancing cylinders 242.1 and 242.2 when laden and respectively manipulators 210.1 and 210.2. Said means 95 for controlling the cylinders 242.1 and 242.2 achieve a balancing of the moments of the weight of the manipulated load, whereas, in the case of a single manipulator, the counterbalancing force generated by the cylinder 42 is regulated and constant for a given load. Thus, the combined movements of the two manipulators 210.1 and 210.2 as well as the assembly of the load 220 to be manipulated on ball pins 110.1 and 110.2 permit the balancing—and the guiding—of the load 220 with five degrees of freedom. If one considers an orthogonal system of axes Oxyz connected to the centre of the load 220, and of which the axis Ox has the same direction as an axis connecting the centres of the ball joints 110.1 and 110.2, the five degrees of freedom controlled by the movements of the manipulators 210.1 and 210.2 correspond to the translations in the axes Ox, Oy and Oz as well as the rotations about the axes Oz and Oy.

FIG. 13 represents a third embodiment that is identical to the previously described embodiment depicted in FIG. 11 and in which the plate 221.1 comprises a drive shaft 120 connected to a plate 121 receiving in rotation an axis 122 connected to the load 220. A motor 123 that is integral with the plate 121 actuates a first toothed wheel 124 engaging with a second toothed wheel 125 that is integral with the shaft 122. The motor 123 is connected to the monitoring unit 290 and is controllable by an operator. In this way, the motor 123 makes it possible for the control of the balancing of the load according to the sixth and last degree of freedom, that is to say the rotation about the axis Ox, to be assured.

The invention is not limited to the described embodiments, of course, but encompasses any variant falling within the scope of the invention as defined by the claims.

In particular,
although the load in this case is connected to the manipulator with the help of an attachment plate, the invention applies similarly to other means of attachment of a load, for example a hook, a shackle, a flexible sling, a spreader as well as any other additional articulated system having one or a plurality of degrees of freedom, whether motorized or non-motorized, and more specifically a motorized mechanism capable of allowing a rotation in a vertical axis;
although the balancing when unladen of the manipulator is performed in this case with the help of counterweights, the invention applies similarly to other balancing means when unladen, for example, a cylinder or an electric actuator;
although the balancing of the manipulator when laden is performed in this case with the help of a cylinder, the invention applies similarly to other balancing means when laden, for example a counterweight, an electric motor or an elastic system;
although the measurement in this case of the position of each of the elements of the manipulator is undertaken with the help of coders situated in the motors of the cable-actuated cylinders, the invention applies similarly to other means of measurement of the position of each of the elements of the manipulator, for example, coders positioned at each articulation, accelerometers or an optical camera;
although the guidance means in this case comprise cable-actuated cylinders, the invention applies similarly to other types of guidance means, for example hydraulic cylinders, electrical cylinders or motors;
although the maximum force developed in this case by the guidance means is 50 Newtons for a weight of the manipulated load of up to 1000 Newtons, the invention applies similarly to other maximum values of the forces developed by the guidance means and of the weight of the load to be manipulated. It is possible in particular to conceive of a load manipulating device having regard for specific standards for lifting objects (balancing when laden and when unladen) and standards relative to the contact forces that are capable of being withstood by humans, said values being capable of varying according to the type of tasks or national legislation;
although the means of modelling in this case comprise the three-dimensional modeller in the 3DXML format, the invention applies similarly to other types of three-dimensional modeller, for example 3D turbo©, Hypermesh© or Catia©, as well as to any other modeller capable of providing a mesh in a format of the “obj” type;
although the generation of guiding or anti-collision instructions in this case is based on a 3D model defined a priori, the invention applies similarly to the models obtained with other modelling tools and in particular to those obtained or modified in real time by sensors that are capable of providing point clouds, such as 3D cameras or remote-sensing lasers;
although the means for balancing the rotation of the load about an axis connecting the ends of the manipulators in this case comprises two toothed wheels interacting together, the invention is applicable to other complementary means of counterbalancing the load connected to the ends of the manipulators, for example a pulley-belt linkage, a linkage between two smooth wheels, a movement initiated by a telescopic actuator or some other type of rotary actuator.

1. Load manipulating device including a load manipulator including at least two segments articulated with respect to each other, comprising a boom segment that is also articulated on a frame and a balance segment which comprises an end intended to receive a load to be manipulated, characterized in that the load manipulating device comprises balancing means such that the load manipulator is stable in any position, whether or not bearing the load, and guidance means distinct from the balancing means for constraining the position of the load manipulator.

2. Load manipulating device according to claim 1, in which the load manipulator comprises a connecting rod parallel to a boom segment articulated on the frame, the boom segment and the connecting rod having first ends articulated on a balance segment, one end being intended to be connected to the load to be manipulated, and the second ends of the boom segment (13) and of the connecting rod (14) being connected by a rod (15) in such a way as to form a deformable parallelogram, the balancing means (41, 23, 24) comprising balancing means when unladen (23, 24) to balance the load manipulator (10) when unladen and balancing means when laden (41) to balance the load manipulator (10) when laden.

3. Load manipulating device according to claim 1, comprising means of measuring the position of each of the elements of the load manipulator and means of three-dimensional modelling of the elements of the load manipulator, of its environment and/or of the load intended to be connected to the end of the balance segment (18), the load manipulating device (1) similarly comprising means of processing the modelled elements in order to detect a movement of the load manipulator that could lead to a collision between the modelled elements and in order to send an instruction to the guidance means of the load manipulator (10) in order for them to generate a force opposing the movement that could lead to the collision.

4. Load manipulating device according to claim 1, in which the guidance means of the manipulator comprise a cable-actuated cylinder.

5. Load manipulating device according to claim 3, in which the means of processing the modelled elements comprise storage means for at least one modelling of a reference trajectory of the load to be manipulated, the means of processing the modelled elements being arranged in order to detect a movement of the load manipulator that could lead to a difference between the modelling of the trajectory of the load and the modelling of the reference trajectory, and in order to send an instruction to the guidance means of the load manipulator in order for them to generate a force opposing the movement of the load manipulator and that could lead to a difference between the modelling of the trajectory of the load and the modelling of the reference trajectory.

6. Load manipulating device according to claim 1, comprising a second load manipulator positioned parallel with a first load manipulator, the ends of each manipulator being connected to the load to be manipulated by means of connection comprising at least one ball joint, the load manipulating device similarly comprising means for controlling the balancing means of each manipulator.

7. Load manipulating device according to claim 6, in which the means of connection comprise means of balancing the rotation of the load about an axis connecting the ends of the manipulators.
